(19) United States
(12) Patent Application Publication
(10) Pub. No.: US 2026/0036807 A1
(43) Pub. Date: Feb. 5, 2026

(54) VEHICULAR CAMERA

(71) Applicant: Panasonic Automotive Systems Co., Ltd., Kanagawa (JP)

(72) Inventor: Tadafumi KUROGI, Kanagawa (JP)

(73) Assignee: Panasonic Automotive Systems Co., Ltd., Kanagawa (JP)

(21) Appl. No.: 19/270,914

(22) Filed: Jul. 16, 2025

(30) Foreign Application Priority Data
Jul. 31, 2024 (JP) 2024-124636

(51) Int. Cl. G02B 27/00; G03B 17/12; G03B 30/00; H04N 23/51; H04N 23/52; H04N 23/54; H04N 23/55; H04N 23/57

(52) U.S. Cl. CPC G02B 27/0006; G03B 17/12; G03B 30/00; H04N 23/51; H04N 23/52; H04N 23/54; H04N 23/55; H04N 23/57; G03B 2217/002

(57) ABSTRACT

A vehicular camera includes a lens barrel including at least one lens disposed along an optical axis, an imaging element, a circuit board having a first surface on which the imaging element is disposed, a first housing accommodating at least the imaging element and the circuit board, a coaxial connector electrically connected to the circuit board and outputting an image signal from the imaging element to the outside. The vehicular camera includes a piezoelectric element disposed near the second end portion and vibrating the at least one lens, a flexible substrate connected to the piezoelectric element so as to be exposed to an inside of the first housing, and a piezoelectric element connector connected to the flexible substrate and extending from the flexible substrate to the fourth end portion of the first housing at a position outside the coaxial connector in a radial direction orthogonal to the optical axis.

### TECHNICAL FIELD

The present disclosure relates to a vehicular camera.

With demands for improvements in vehicle safety, introduction of autonomous driving functions, and the like in recent years, development of vehicular cameras that are mounted on vehicles and capture the inside and outside of the vehicles have become active (for example, see Patent Literatures 1 and 2).

### CITATION LIST

### Patent Literature

Patent Literature 1: JP2017-170303A
Patent Literature 2: WO2023/127197

### SUMMARY OF INVENTION

Required levels relating to safety, automatic driving functions, and the like, which are required for vehicles, are improved, and further improvement in performance and the like are also required for vehicular cameras.

The present disclosure relates to a technique for providing a new vehicular camera.

The present disclosure provides a vehicular camera including a lens barrel having a first tubular shape along an optical axis and including a first end portion having the first tubular shape, a second end portion having the first tubular shape and opposite to the first end portion, and at least one lens disposed along the optical axis; an imaging element disposed closer to the second end portion than the first end portion having the first tubular shape of the lens barrel on the optical axis; a circuit board having a first surface on which the imaging element is disposed and a second surface opposite to the first surface; a first housing accommodating at least the imaging element and the circuit board, having a second tubular shape along the optical axis, and including a third end portion having the second tubular shape and a fourth end portion having the second tubular shape and disposed farther away from the third end portion with reference to the first end portion having the first tubular shape of the lens barrel; a coaxial connector having at least a part disposed in the fourth end portion having the second tubular shape, including a first connector end and a second connector end opposite to the first connector end, the first connector end being electrically connected to the circuit board, and inputting power from an outside and outputting an image signal from the imaging element to the outside; a piezoelectric element disposed near the second end portion having the first tubular shape of the lens barrel and vibrating the at least one lens; a flexible substrate connected to the piezoelectric element so as to be exposed to an inside of the first housing; and a piezoelectric element connector connected to the flexible substrate and extending from the flexible substrate to the fourth end portion of the first housing at a position outside the coaxial connector in a radial direction orthogonal to the optical axis.

According to the present disclosure, foreign matters such as raindrops adhering to the lens can be removed by vibration of the piezoelectric element. Further, the coaxial connector and the piezoelectric element connector existing in the related art can be separately configured, an increase in cost can be prevented, and an increase in size of the vehicular camera can also be prevented.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras provided in the vehicle illustrated in FIG. 1, a camera ECU, and a display;

FIG. 3 is another example of the vehicle, and is a schematic diagram of a cabin of the vehicle on which a vehicular camera is mounted;

FIG. 4 is a top view of the vehicle in FIG. 3;

FIG. 5 is a block diagram illustrating a connection example of the vehicular camera provided in the vehicle illustrated in FIG. 3, a camera ECU, and a display device;

FIG. 6A is a front perspective view of a vehicular camera according to an embodiment;

FIG. 6B is a rear perspective view of the vehicular camera according to the embodiment;

FIG. 7 is an exploded perspective view of the vehicular camera according to the embodiment;

FIG. 8 is a top view of the vehicular camera according to the embodiment;

FIG. 9 is a cross-sectional view taken along a line I-I in FIG. 8;

FIG. 10 is an enlarged view of a region A in FIG. 9;

FIG. 11 is a perspective view of a piezoelectric element viewed from below;

FIG. 12 is a perspective view of a cross section taken along a line II-II in FIG. 9; and

FIG. 13 is a circuit diagram of the vehicular camera and a vehicle.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for those skilled in the art to sufficiently understand the present disclosure, and are not intended to limit the subject matter described in the claims.

(Vehicle on which Vehicular Camera is Mounted)

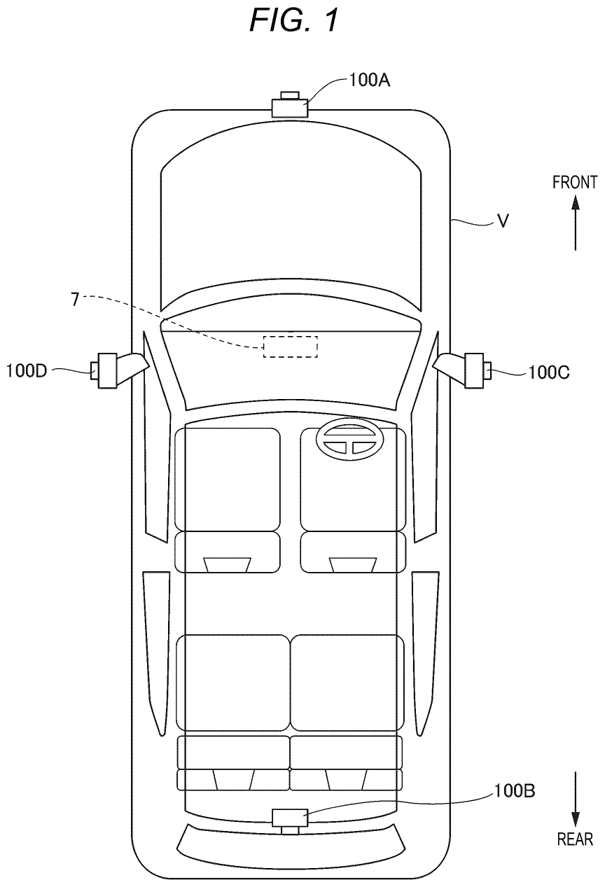

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images showing an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

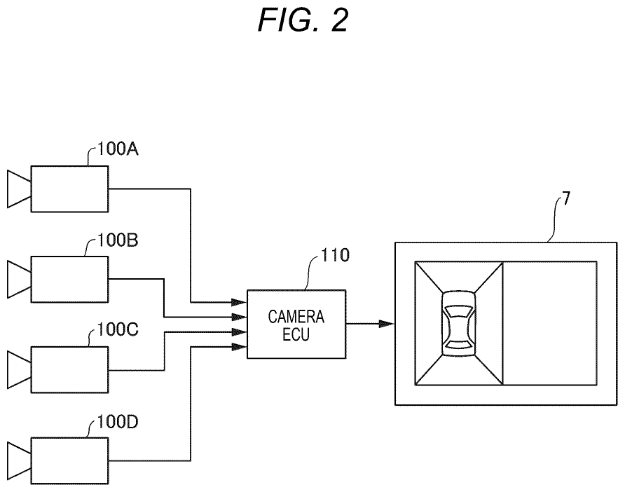

FIG. 2 is a block diagram illustrating a connection example of the vehicular cameras 100A to 100D provided in the vehicle V illustrated in FIG. 1, a camera ECU 110, and a display 7. The camera electronic control unit (ECU) 110 in FIG. 2 synthesizes the images captured by the vehicular cameras 100A to 100D, and displays a synthesized image on the display 7 of a navigation system disposed on an instrument panel, for example. An occupant can visually recognize the display 7 and check a situation around the vehicle V.

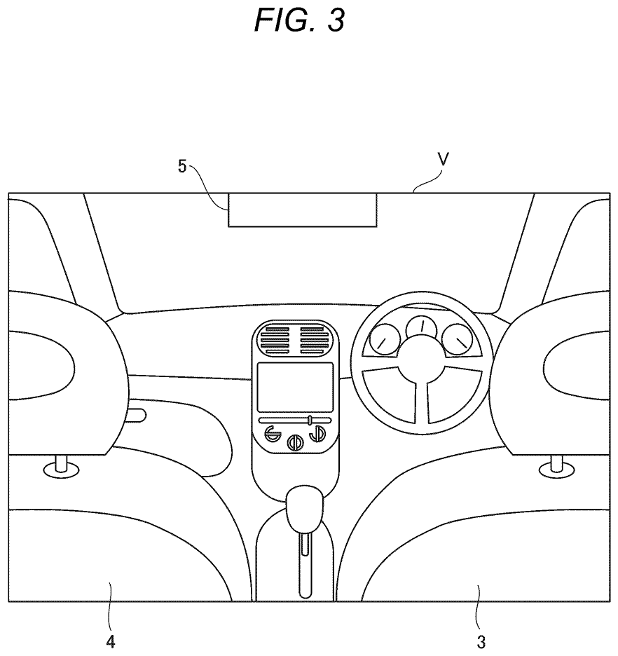

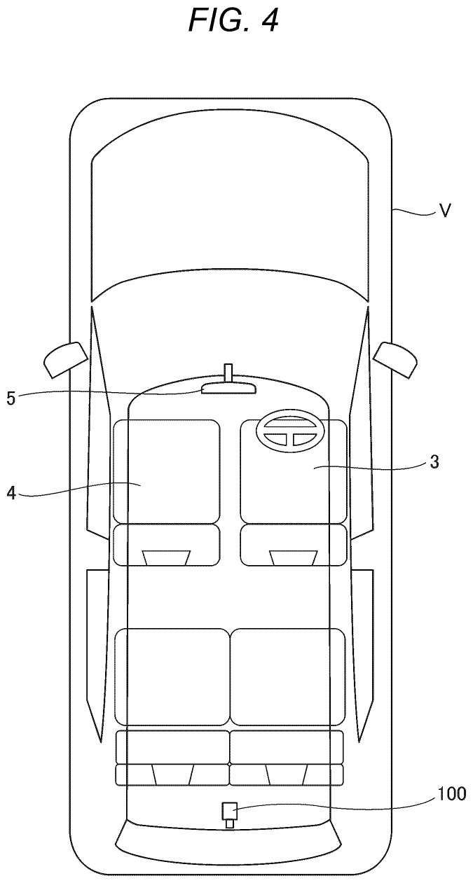

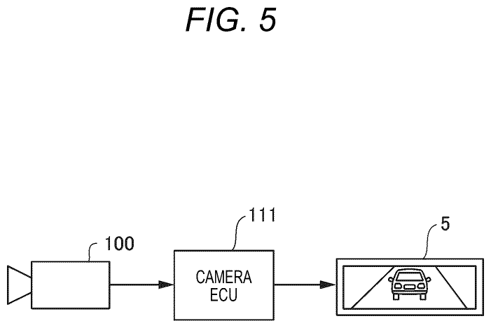

FIG. 3 is another example of the vehicle, and is a schematic diagram of a cabin of the vehicle on which the vehicular camera is mounted, and FIG. 4 is a top view of the vehicle in FIG. 3. The vehicle V includes a display device 5 (for example, an electronic rearview mirror) at an attachment position of a rearview mirror which is a front portion between a driver's seat 3 and a passenger seat 4 in a cabin 2. Further, the vehicle V is provided with the vehicular camera 100 at a rear side of a vehicle body. FIG. 5 is a block diagram illustrating a connection example of the vehicular camera 100 provided in the vehicle V illustrated in FIG. 3, a camera ECU 111, and the display device 5. The camera electronic control unit (ECU) 111 in FIG. 4 processes an image captured by the vehicular camera 100, and the display device 5 displays the image. The occupant can visually recognize the display device 5 and check a rear situation of the vehicle V.

### (Embodiment of Vehicular Camera)

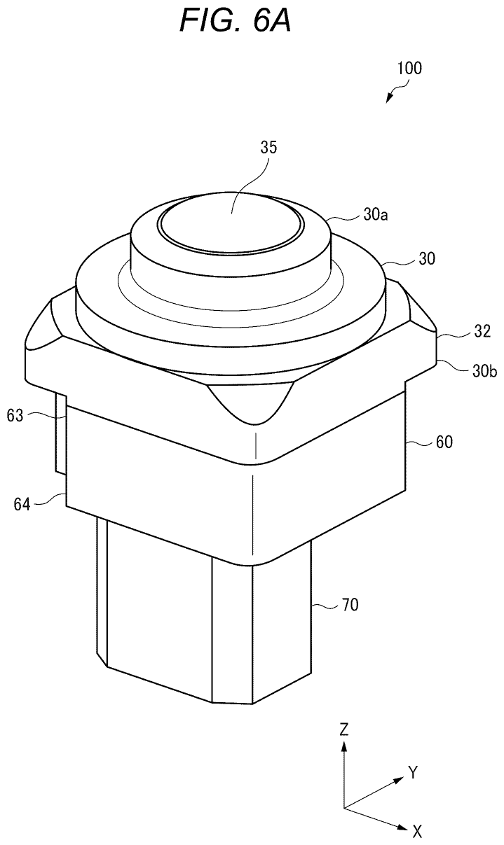

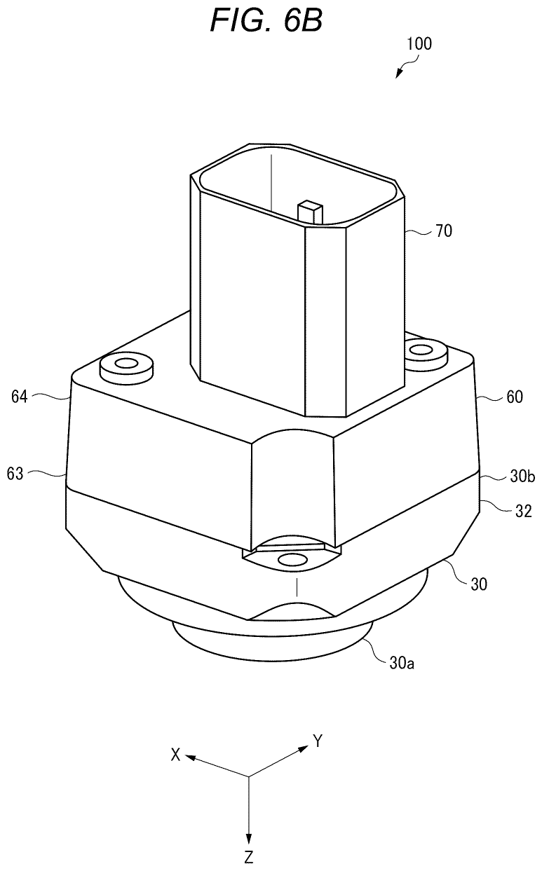

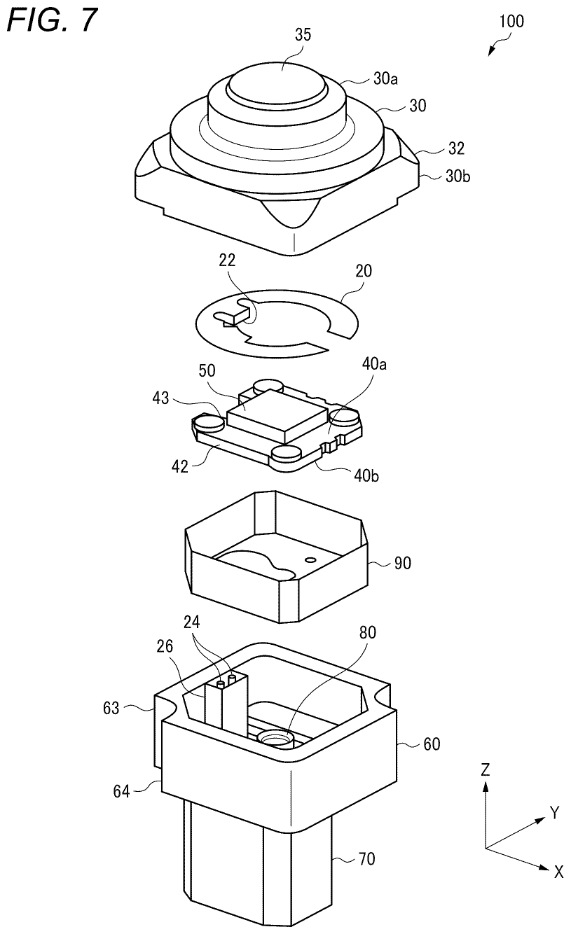

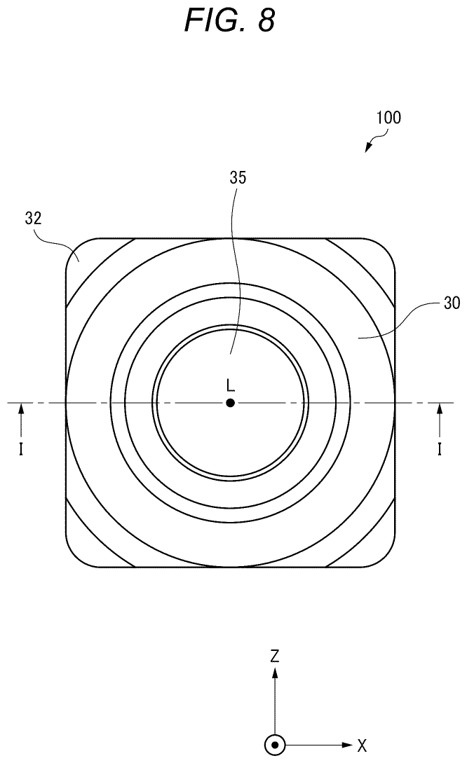

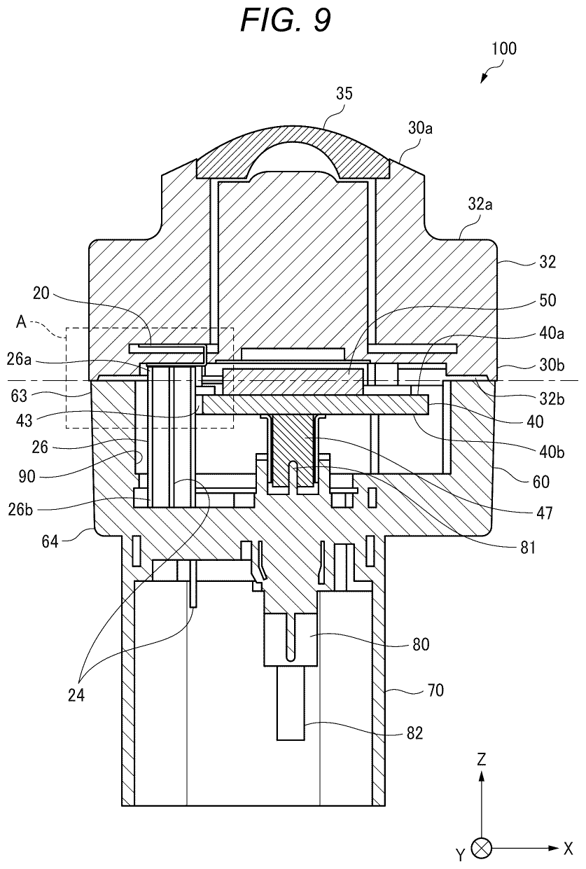

FIG. 6A is a front perspective view of the vehicular camera 100 according to an embodiment, and FIG. 6B is a rear perspective view of the vehicular camera 100 according to the embodiment. FIG. 7 is an exploded perspective view of the vehicular camera 100 according to the embodiment. FIG. 8 is a top view of the vehicular camera 100 according to the embodiment. FIG. 9 is a cross-sectional view taken along a line I-I in FIG. 8. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 of the present embodiment includes a lens barrel 30, a piezoelectric element 20, a circuit board 40, an imaging element 50, a first housing 60, a second housing 70, and a box-shaped shield 90.

The lens barrel 30 has a first tubular shape along an optical axis L (a direction orthogonal to the paper surface of FIG. 8 and along the Z axis), and has a first end portion 30a and a second end portion 30b opposite to the first end portion 30a in the direction along the optical axis L (the direction orthogonal to the paper surface of FIG. 8 and along the Z axis).

The first end portion 30a forms a distal end portion of the lens barrel 30, and at least a part of the second end portion 30b faces the imaging element 50 and the circuit board 40 inside the first housing 60.

The lens barrel 30 includes at least one lens 35 disposed on the optical axis L. The lens barrel 30 holds therein, for example, a lens group including a plurality of lenses 35. The respective lenses 35 in the lens group are arranged in a state in which respective optical axes L are aligned with each other, and constitute the lens group used for capturing images of the inside and outside of the vehicle body of the vehicle V.

Further, the lens barrel 30 has a flange portion 32 disposed at the second end portion 30b to extend outward with reference to the optical axis L over an entire circumference centering on the optical axis L. The flange portion 32 has a first flange surface 32a facing at least a part of an upper surface of the piezoelectric element 20 and a second flange surface 32b opposite to the first flange surface 32a.

At least the second flange surface 32b of the lens barrel 30 can be molded with a first resin. The lens barrel 30 may be entirely molded with the first resin. Accordingly, the lens barrel 30 can be easily molded at low cost. The lens barrel 30 may be made of metal.

In FIG. 9, the inside of the lens barrel 30 is not illustrated in detail, and only one lens (first lens) 35 exposed to the outside in the first end portion 30a is illustrated. For a specific example of an internal structure of the lens barrel 30, for example, the contents of Patent Literature 2 can be referred to.

The imaging element 50 is disposed in an internal space of the first housing 60 on the optical axis L and closer to the second end portion 30b than the first end portion 30a of the lens barrel 30. The imaging element 50 is electrically connected to a circuit of the circuit board 40, and can capture an image by directing external light to the imaging element 50. The imaging element 50 may be, for example, a complementary metal-oxide-semiconductor (CMOS) image sensor.

The circuit board 40 is disposed in the internal space of the first housing 60, and includes a first surface 40a and a second surface 40b opposite to the first surface 40a. However, two or more circuit boards may be provided. The imaging element 50 is disposed on the first surface 40a of the circuit board 40.

The circuit board 40 has a quadrangular shape in a plan view. The shape in a plan view is a shape when viewed in a direction from the first surface 40a to the second surface 40b of the circuit board 40. The circuit board 40 has, for example, a quadrangular shape as in the embodiment, but may have a polygonal shape having five or more sides.

The first housing 60 is a tubular member having the internal space, and serves to accommodate at least the circuit board 40 and the imaging element 50. The first housing 60 has a second tubular shape along the optical axis L. The first housing 60 having the second tubular shape has a third end portion 63 and a fourth end portion 64. The third end portion 63 is connected to the flange portion 32 of the lens barrel 30. The fourth end portion 64 is opposite to the third end portion 63 in the direction along the optical axis L, and is disposed farther away from the third end portion 63 with reference to the first end portion 30a of the lens barrel 30. At least the third end portion 63 of the first housing 60 can be molded with a second resin. The first housing 60 may be entirely molded with the second resin. The first housing 60 may be made of metal.

The second housing 70 has a third tubular shape along the optical axis L, and is formed to extend in a direction opposite to the direction of the lens barrel 30 from the fourth end portion 64 of the first housing 60. A diameter of the second housing 70 having the third tubular shape is smaller than a diameter of the first housing 60 having the second tubular shape. The second housing 70 serves to accommodate a portion, which is exposed to the outside from the first housing 60, of each of a coaxial connector 80 and a piezoelectric element connector 24, which will be described later in FIG. 9, but the second housing 70 is not an essential constituent.

The first housing 60 and the second housing 70 may be integrally formed, and the first housing 60 and the second housing 70 prepared individually in advance may be bonded by a method such as welding or screwing. In the present embodiment, the first housing 60 and the second housing 70 have a rectangular tubular shape, but are not limited thereto, and may have a polygonal tubular shape other than the rectangular tubular shape, a circular or elliptical tubular shape, or another tubular shape.

In a state in which at least the circuit board 40 and the imaging element 50 are accommodated in the first housing 60, the second flange surface 32b of the flange portion 32 of the lens barrel 30 and the third end portion 63 of the first housing 60 are welded to each other over the entire circumference. The welding is performed by, for example, laser welding.

General laser welding is used for welding, for example, a first resin having a predetermined light transmittance and a second resin having a light transmittance lower than the light transmittance of the first resin at a wavelength of laser light. When the first resin is irradiated with the laser light in a state in which pressure is applied to both the resins, the laser light is not absorbed and passes through the first resin. The transmitted laser light is absorbed by a surface of the second resin having light transmittance lower than that of the first resin. The energy of the absorbed laser is converted into heat, and the surface of the second resin is heated. Further, a surface of the first resin in contact with the surface of the second resin is also heated due to heat conduction. Accordingly, the first resin and the second resin are melted at a boundary surface therebetween. When the laser emission is stopped, the melted resin is solidified and both resins are welded.

In the present embodiment, at least the second flange surface 32b of the flange portion 32 of the lens barrel 30 is molded with the first resin, and at least the third end portion 63 of the first housing 60 is molded with the second resin. In the laser welding, in a state in which the second flange surface 32b of the flange portion 32 of the lens barrel 30 is pressed against the third end portion 63 of the first housing 60, the laser is emitted from the flange portion 32 side to weld the second flange surface 32b and the third end portion 63. When the first housing 60 is made of metal and the lens barrel 30 is also made of metal, the second flange surface 32b of the flange portion 32 of the lens barrel 30 and the third end portion 63 of the first housing 60 may be welded to each other over the entire circumference. When one of the first housing 60 and the lens barrel 30 is made of metal and the other is made of resin, the first housing 60 and the lens barrel 30 may be fastened together with screws.

The box-shaped shield 90 is a box-shaped conductive member accommodated inside the first housing 60. The box-shaped shield 90 is formed of a conductive metal or the like and serves to shield internal and external noise of the first housing 60.

The vehicular camera 100 further includes the coaxial connector 80 having at least a part disposed in the fourth end portion 64 of the first housing 60. The coaxial connector 80 includes a first connector end 81 and a second connector end 82 opposite to the first connector end 81, and the first connector end 81 is electrically connected to the circuit board 40. The coaxial connector 80 can receive power from the vehicle V as a power supply of the vehicular camera 100 and supply the power to the circuit board 40, and is set to output an image signal from the imaging element 50 to the outside.

In the embodiment, the circuit board 40 and the coaxial connector 80 are connected via a connector connection portion 47. The connector connection portion 47 is disposed on the second surface 40b of the circuit board 40 and is connected to the first connector end 81 of the coaxial connector 80. The connector connection portion 47 has, for example, a structure of a floating pin having a spring, and can absorb a positional error between the circuit board 40 and the coaxial connector 80. However, the circuit board 40 and the coaxial connector 80 may be directly connected to each other.

The vehicular camera 100 is mounted on the vehicle V in a state in which a portion, particularly, a portion of the lens 35 is exposed to the outside, and foreign matters such as raindrops may adhere to the lens 35. Since such foreign matters hinder imaging, it is desired to quickly remove the foreign matters.

To cope with such a problem, the vehicular camera 100 of the present embodiment further includes the piezoelectric element 20 that is disposed near the second end portion 30b of the lens barrel 30 having the first tubular shape and vibrates at least one lens 35. The piezoelectric element 20 is driven by receiving power supplied by a method to be described later, and vibrates the lens 35 directly or indirectly connected to the piezoelectric element 20. Accordingly, the foreign matters adhering to the lens 35 can be removed.

The piezoelectric element 20 has a substantially annular shape (substantially C-shape) on an XY plane, is a flat plate-shaped member, and is formed to substantially surround the optical axis L. The piezoelectric element 20 is connected to the lens 35 exposed to the outside inside the lens barrel 30 using a transmission member not illustrated in FIG. 9. When the piezoelectric element 20 is driven, vibration caused by the driving is transmitted to the lens 35 via the transmission member (not illustrated), and the lens 35 vibrates. Since the piezoelectric element 20 is formed to correspond to an entire peripheral edge of the lens 35, the vibration is transmitted to the entire peripheral edge of the lens 35, and the foreign matters adhering to the lens 35 can be efficiently removed.

As the transmission member not illustrated in FIG. 9, for example, a known member such as a spring described in Patent Literature 2 can be used, but a mode of connection between the lens 35 and the piezoelectric element 20 is not particularly limited.

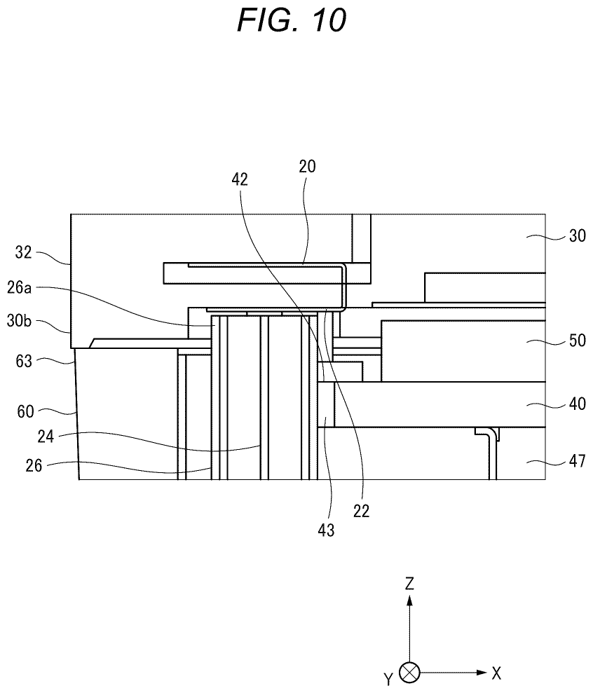

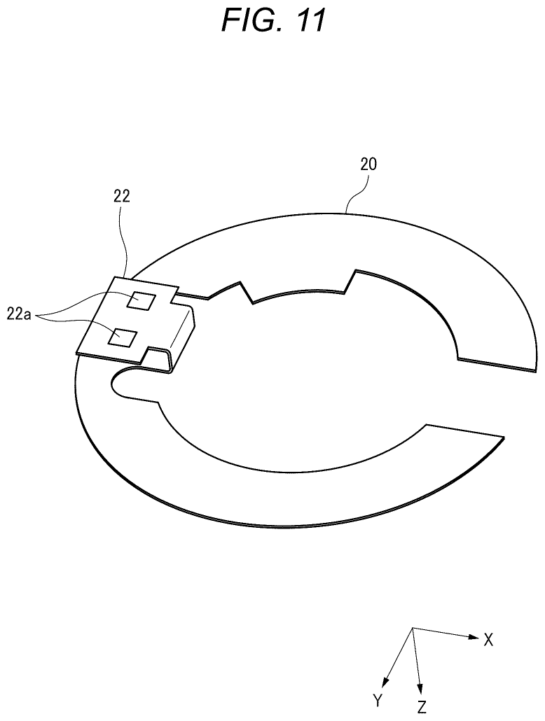

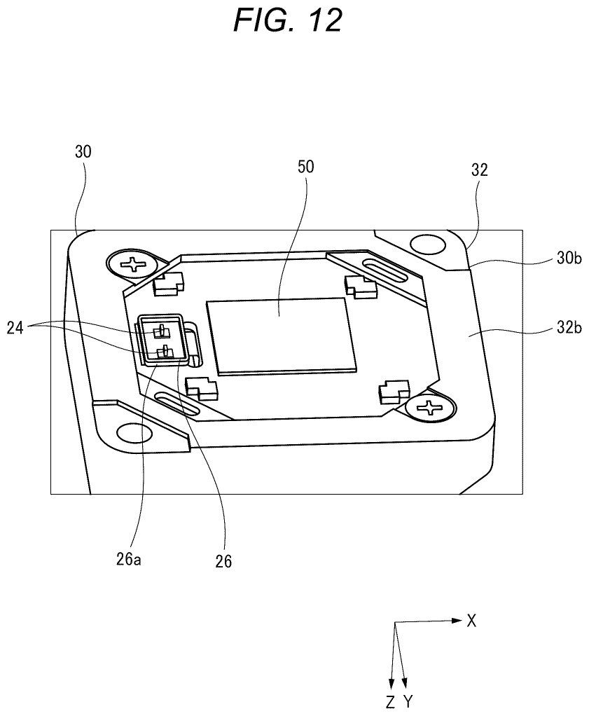

FIG. 10 is an enlarged view of a region A in FIG. 9. FIG. 11 is a perspective view of the piezoelectric element 20 when viewed from below and viewed from a direction opposite to FIG. 9 in the Z axis. FIG. 12 is a perspective view of a cross section taken along a line II-II in FIG. 9. The piezoelectric element 20 is connected to a flexible substrate 22 near the second end portion 30b. The flexible substrate 22 is connected to a part of the piezoelectric element 20 in a circumferential direction, is bent from a connection point with the piezoelectric element 20, and is exposed to the inside of the first housing 60.

The flexible substrate 22 has a pad 22a for electrical connection on a surface exposed to the inside of the first housing 60. The piezoelectric element connector 24 is connected to the pad 22a of the flexible substrate 22. The piezoelectric element connector 24 extends from a connection point with the flexible substrate 22 to the fourth end portion 64 of the first housing 60 at a position outside the coaxial connector 80 in a radial direction orthogonal to the optical axis L.

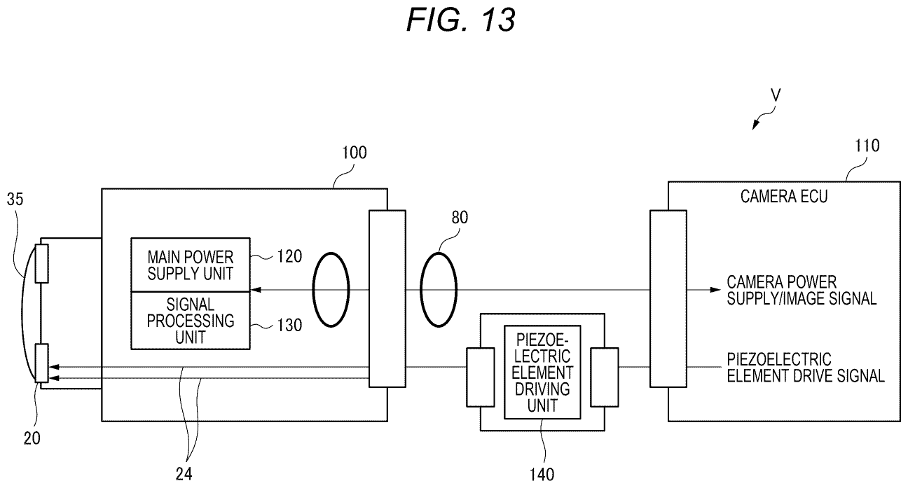

FIG. 13 is a circuit diagram of the vehicular camera 100 and the vehicle V. The vehicular camera 100 is connected to the vehicle V via the coaxial connector 80. The vehicle V includes the camera ECU 110 that controls the vehicular camera 100. The camera ECU 110 supplies a current to a main power supply unit 120 of the vehicular camera 100 itself via the coaxial connector 80. A signal processing unit 130 of the vehicular camera 100 supplies a signal of a video captured by the imaging element 50 to the vehicle V via the coaxial connector 80.

Further, the camera ECU 110 controls a piezoelectric element driving unit 140 that supplies a current to the piezoelectric element 20. The piezoelectric element driving unit 140 supplies a current to the piezoelectric element connector 24 in response to the control of the camera ECU 110, and the current is supplied to the piezoelectric element 20 via the flexible substrate 22. In this figure, the piezoelectric element driving unit 140 is provided on the vehicle side, but may be provided in the vehicular camera 100.

Although the current supplied to the piezoelectric element connector 24 is significantly larger than the current supplied to the coaxial connector 80 and the piezoelectric element driving unit 140 is specially provided, a role of the piezoelectric element connector 24 and a role of the coaxial connector 80 are completely different from each other, and it is difficult to configure both with one connector. Even if it is possible to design a connector that serves both as the coaxial connector 80 and the piezoelectric element connector 24, such a connector may have a complicated structure, leading to an increase in size and cost.

In the present embodiment, the coaxial connector 80 and the piezoelectric element connector 24 existing in the related art can be separately configured, an increase in cost can be prevented, and an increase in size of the vehicular camera can also be prevented. In particular, in the present embodiment, the piezoelectric element connector 24 is provided away from the coaxial connector 80 at a position outside the coaxial connector 80 in the radial direction orthogonal to the optical axis L. Therefore, the coaxial connector 80 and the piezoelectric element connector 24 can be provided with simple structures without complicating respective structures thereof.

In the present embodiment, the flexible substrate 22 is disposed farther away from the first surface 40a of the circuit board 40 with reference to the first connector end 81 of the coaxial connector 80. That is, the piezoelectric element connector 24 is connected to the flexible substrate 22 and the piezoelectric element 20 at a position farther away from the circuit board 40 when viewed from the coaxial connector 80. Accordingly, it is possible to ensure the connection between the piezoelectric element connector 24 and the piezoelectric element 20 while avoiding interference with the coaxial connector 80 and the circuit board 40.

In particular, in the present embodiment, the piezoelectric element connector 24 extends from the flexible substrate 22 to the fourth end portion 64 of the first housing 60 while penetrating a part of the circuit board 40. Specifically, a notch 43 is provided at an edge 42 of the circuit board 40, and the piezoelectric element connector 24 penetrates the notch 43. Accordingly, the piezoelectric element connector 24 can be easily disposed regardless of the presence of the circuit board 40.

In addition, in a case where at least a part of the first housing 60 is formed of resin (second resin), even if the box-shaped shield 90 is provided, noise inside and outside the first housing 60 cannot be sufficiently shielded, and the noise may interfere with the piezoelectric element connector 24. Therefore, the vehicular camera 100 of the present embodiment further includes a shield member 26 made of metal that covers a periphery of the piezoelectric element connector 24 from the flexible substrate 22 to the fourth end portion 64 of the first housing 60. The presence of the shield member 26 made of metal can prevent the noise from interfering with the piezoelectric element connector 24. When the first housing 60 is made of metal, the box-shaped shield 90 may not be provided in the first housing 60.

Specifically, the shield member 26 is a tubular metal member having one end 26a connected to the flexible substrate 22 and the other end 26b connected to the fourth end 64 of the first housing 60. Accordingly, it is possible to prevent the noise from interfering with the piezoelectric element connector 24 with a simple configuration.

As described above, although the circuit board 40 has the notch 43 at the edge 42, the shield member 26 penetrates the notch 43 in addition to the piezoelectric element connector 24. Accordingly, the piezoelectric element connector 24 and the shield member 26 can be easily disposed regardless of the presence of the circuit board 40. In particular, the piezoelectric element connector 24 and the shield member 26 can be easily disposed by slight deformation of the circuit board 40, which is the notch 43.

The piezoelectric element connector 24 can be configured by, for example, a two-pin connector including two pins. Accordingly, the piezoelectric element connector 24 can be easily formed. When the piezoelectric element connector 24 is a two-pin connector, the two pins are connected to two pads 22a illustrated in FIG. 12.

The piezoelectric element connector 24 is exposed to the outside of the first housing 60 from the fourth end portion 64 of the first housing 60. Accordingly, the piezoelectric element connector 24 can be connected to an external conductive member. In FIG. 9, a radial position of the piezoelectric element connector 24 inside the first housing 60 is different from a radial position of the piezoelectric element connector 24 outside the first housing 60, but the piezoelectric element connector 24 is bent in the fourth end portion 64 of the first housing 60. Further, the two pins of the piezoelectric element connector 24 in the X direction overlap at the position exposed from the first housing 60 (appearing as a single pin in FIG. 9).

The coaxial connector 80 is also exposed to the outside of the first housing 60 from the fourth end portion 64 of the first housing 60, and accordingly, the piezoelectric element connector 24 is exposed to the outside of the first housing 60 from the fourth end portion 64 of the first housing 60 at the position outside the coaxial connector 80 in the radial direction. Accordingly, the piezoelectric element connector 24 can be exposed to the outside while maintaining the position where the coaxial connector 80 is exposed to the outside (a center position in the radial direction) at the prior position.

As in the embodiment, the vehicular camera 100 may further include the second housing 70 that has a third tubular shape along the optical axis L and extends in a direction opposite to the direction of the lens barrel 30 from the fourth end portion 64 of the first housing 60. The coaxial connector 80 and the piezoelectric element connector 24 are disposed to extend from the fourth end portion 64 of the first housing 60 to an internal space of the second housing 70. Accordingly, the coaxial connector 80 and the piezoelectric element connector 24, which are exposed to the outside from the first housing 60, can be protected.

As in the embodiment, the coaxial connector 80 and the piezoelectric element connector 24 may be configured not to protrude from the second housing 70. Accordingly, since the coaxial connector 80 and the piezoelectric element connector 24, which are exposed to the outside from the first housing 60, are located inside the second housing 70, it is possible to avoid contact with other members and to facilitate handling.

From the above, at least the following matters are described in the present disclosure. Components corresponding to those in the embodiment are shown in parentheses, but the present disclosure is not limited thereto.
(1) A vehicular camera (vehicular camera 100) including:
a lens barrel (lens barrel 30) having a first tubular shape along an optical axis (optical axis L) and including a first end portion (first end portion 30a) having the first tubular shape, a second end portion (second end portion 30b) having the first tubular shape and opposite to the first end portion, and at least one lens (lens 35) disposed along the optical axis;
an imaging element (imaging element 50) disposed closer to the second end portion than the first end portion having the first tubular shape of the lens barrel on the optical axis;
a circuit board (circuit board 40) having a first surface (first surface 40a) on which the imaging element is disposed and a second surface (second surface 40b) opposite to the first surface;
a first housing (first housing 60) configured to accommodate at least the imaging element and the circuit board, having a second tubular shape along the optical axis, and including a third end portion (third end portion 63) having the second tubular shape and a fourth end portion (fourth end portion 64) having the second tubular shape and disposed farther away from the third end portion with reference to the first end portion having the first tubular shape of the lens barrel;
a coaxial connector (coaxial connector 80) having at least a part disposed in the fourth end portion having the second tubular shape, including a first connector end and a second connector end opposite to the first connector end, the first connector end being electrically connected to the circuit board, and set to output an image signal from the imaging element to an outside;
a piezoelectric element (piezoelectric element 20) disposed near the second end portion having the first tubular shape of the lens barrel and configured to vibrate the at least one lens;
a flexible substrate (flexible substrate 22) connected to the piezoelectric element so as to be exposed to an inside of the first housing; and
a piezoelectric element connector (piezoelectric element connector 24) connected to the flexible substrate and extending from the flexible substrate to the fourth end portion of the first housing at a position outside the coaxial connector in a radial direction orthogonal to the optical axis.

Accordingly, foreign matters such as raindrops adhering to the lens can be removed by vibration of the piezoelectric element. Further, the coaxial connector and the piezoelectric element connector existing in the related art can be separately configured, an increase in cost can be prevented, and an increase in size of the vehicular camera can also be prevented.
(2) The vehicular camera according to (1), in which
the flexible substrate is disposed farther away from the first surface of the circuit board with reference to the first connector end of the coaxial connector.

Accordingly, it is possible to ensure the connection between the piezoelectric element connector and the piezoelectric element while avoiding interference with the coaxial connector and the circuit board.
(3) The vehicular camera according to (1), in which
the piezoelectric element connector extends from the flexible substrate to the fourth end portion of the first housing while penetrating a part of the circuit board.

Accordingly, the piezoelectric element connector can be easily disposed regardless of the presence of the circuit board.
(4) The vehicular camera according to (3), in which
at least a part of the first housing is formed of resin, and
the vehicular camera further includes a shield member (shield member 26) made of metal and configured to cover a periphery of the piezoelectric element connector from the flexible substrate to the fourth end portion of the first housing.

Accordingly, it is possible to prevent noise from interfering with the piezoelectric element connector.
(5) The vehicular camera according to (4), in which
the shield member is a tubular metal member having one end (one end 26a) connected to the flexible substrate and the other end (the other end 26b) connected to the fourth end portion of the first housing.

Accordingly, it is possible to prevent the noise from interfering with the piezoelectric element connector with a simple configuration.
(6) The vehicular camera according to (4), in which
the circuit board has a notch (notch 43), and
the piezoelectric element connector and the shield member penetrate the notch.

Accordingly, the piezoelectric element connector and the shield member can be easily disposed regardless of the presence of the circuit board.
(7) The vehicular camera according to (6), in which
the notch is formed at an edge (edge 42) of the circuit board.

Accordingly, the piezoelectric element connector and the shield member can be easily disposed by slight deformation of the circuit board.
(8) The vehicular camera according to (1), in which
the piezoelectric element connector is a two-pin connector.

Accordingly, the piezoelectric element connector can be easily formed.
(9) The vehicular camera according to (1), in which
the piezoelectric element connector is exposed to an outside of the first housing from the fourth end portion of the first housing.

Accordingly, the piezoelectric element connector can be connected to an external conductive member.
(10) The vehicular camera according to (9), in which
the coaxial connector is exposed to the outside of the first housing from the fourth end portion of the first housing, and
the piezoelectric element connector is exposed to the outside of the first housing from the fourth end portion of the first housing at a position outside the coaxial connector in the radial direction.

Accordingly, the piezoelectric element connector can be exposed to the outside while maintaining the position where the coaxial connector is exposed to the outside at the prior position.
(11) The vehicular camera according to (6), further including:
a second housing (second housing 70) having a third tubular shape along the optical axis and extending in a direction opposite to a direction of the lens barrel from the fourth end portion of the first housing, in which
the coaxial connector and the piezoelectric element connector are disposed to extend from the fourth end portion of the first housing to an internal space of the second housing.

Accordingly, the coaxial connector and the piezoelectric element connector, which are exposed to the outside from the first housing, can be protected.
(12) The vehicular camera according to (11), in which
the coaxial connector and the piezoelectric element connector do not protrude from the second housing.

Accordingly, since the coaxial connector and the piezoelectric element connector, which are exposed to the outside from the first housing, are located inside the second housing, it is possible to facilitate handling.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

### INDUSTRIAL APPLICABILITY

The present disclosure is useful for a vehicular camera capable of preventing an increase in cost and preventing an increase in size.

### CROSS-REFERENCE TO RELATED APPLICATIONS

This application is based on and claims priority under 35 USC 119 from Japanese Patent Application No. 2024-124636 filed on Jul. 31, 2024, the contents of which are incorporated herein by reference.

What is claimed is:

1. A vehicular camera comprising:
a lens barrel having a first tubular shape along an optical axis and including a first end portion having the first tubular shape, a second end portion having the first tubular shape and opposite to the first end portion, and at least one lens disposed along the optical axis;
an imaging element disposed closer to the second end portion than the first end portion having the first tubular shape of the lens barrel on the optical axis;
a circuit board having a first surface on which the imaging element is disposed and a second surface opposite to the first surface;
a first housing accommodating at least the imaging element and the circuit board, having a second tubular shape along the optical axis, and including a third end portion having the second tubular shape and a fourth end portion having the second tubular shape and disposed farther away from the third end portion with reference to the first end portion having the first tubular shape of the lens barrel;
a coaxial connector having at least a part disposed in the fourth end portion having the second tubular shape, including a first connector end and a second connector end opposite to the first connector end, the first connector end being electrically connected to the circuit board, and inputting power from an outside and outputting an image signal from the imaging element to the outside;
a piezoelectric element disposed near the second end portion having the first tubular shape of the lens barrel and vibrating the at least one lens;
a flexible substrate connected to the piezoelectric element so as to be exposed to an inside of the first housing; and
a piezoelectric element connector connected to the flexible substrate and extending from the flexible substrate to the fourth end portion of the first housing at a position outside the coaxial connector in a radial direction orthogonal to the optical axis.

2. The vehicular camera according to claim 1, wherein
the flexible substrate is disposed farther away from the first surface of the circuit board with reference to the first connector end of the coaxial connector.

3. The vehicular camera according to claim 1, wherein
the piezoelectric element connector extends from the flexible substrate to the fourth end portion of the first housing while penetrating a part of the circuit board.

4. The vehicular camera according to claim 3, wherein
at least a part of the first housing is formed of resin, and
the vehicular camera further includes a shield member made of metal and configured to cover a periphery of the piezoelectric element connector from the flexible substrate to the fourth end portion of the first housing.

5. The vehicular camera according to claim 4, wherein
the shield member is a tubular metal member having one end connected to the flexible substrate and the other end connected to the fourth end portion of the first housing.

6. The vehicular camera according to claim 4, wherein
the circuit board has a notch, and
the piezoelectric element connector and the shield member penetrate the notch.

7. The vehicular camera according to claim 6, wherein
the notch is formed at an edge of the circuit board.

8. The vehicular camera according to claim 1, wherein
the piezoelectric element connector is a two-pin connector.

9. The vehicular camera according to claim 1, wherein
the piezoelectric element connector is exposed to an outside of the first housing from the fourth end portion of the first housing.

10. The vehicular camera according to claim 9, wherein
the coaxial connector is exposed to the outside of the first housing from the fourth end portion of the first housing, and
the piezoelectric element connector is exposed to the outside of the first housing from the fourth end portion of the first housing at a position outside the coaxial connector in the radial direction.

11. The vehicular camera according to claim 10, further comprising:
a second housing having a third tubular shape along the optical axis and extending in a direction opposite to a direction of the lens barrel from the fourth end portion of the first housing, wherein
the coaxial connector and the piezoelectric element connector are disposed to extend from the fourth end portion of the first housing to an internal space of the second housing.

12. The vehicular camera according to claim 11, wherein
the coaxial connector and the piezoelectric element connector do not protrude from the second housing.
